(19) United States
(12) Patent Application Publication
(10) Pub. No.: US 2019/0151975 A1
(43) Pub. Date: May 23, 2019

(54) AUTOMATIC IDENTIFICATION OF COMPONENTS FOR WELDING AND CUTTING SYSTEMS

(71) Applicant: The ESAB Group Inc., Florence, SC (US)

(72) Inventors: Glenn CAMPBELL, Claremont, NH (US); Joshua NOWAK, Hanover, NH (US)

(21) Appl. No.: 16/190,646

(22) Filed: Nov. 14, 2018

Related U.S. Application Data
(60) Provisional application No. 62/587,596, filed on Nov. 17, 2017.

(51) Int. Cl. B23K 9/095; B23K 9/10; B23K 35/02; G06K 7/12

(52) U.S. Cl. CPC B23K 9/0956; G06K 7/12; B23K 35/02; B23K 9/1006

(57) ABSTRACT

Identifying interchangeable components, such as consumables and torch tips, for welding and cutting torches includes adding a luminescent material to a surface of a component. The luminescent material is configured to emit electromagnetic energy with a second spectral signature in response to absorbing electromagnetic energy with a first spectral signature. Electromagnetic energy with various spectral signatures is transmitted to the surface and the component is automatically identified when the surface emits the electromagnetic energy with the first spectral signature. A power supply may automatically adjust operational parameters of the torch including the component in response to the automatic identifying.

### CROSS REFERENCE TO RELATED APPLICATIONS

This application claims priority to and is based on U.S. Patent Application No. 62/587,596, filed Nov. 17, 2017, entitled “Automatic Identification Of Components For Welding And Cutting Torches,” the entire disclosure of which is incorporated herein by reference.

### TECHNICAL FIELD

The present disclosure is directed toward identifying components for welding and cutting systems and, in particular, to automatically identifying interchangeable torches or torch components, such as torch tips and and/or electrodes, for welding and/or cutting torches.

### BACKGROUND

Many welding and cutting torches, such as plasma cutting torches, now include torch bodies that can receive a variety of interchangeable consumable components, such as welding tips, cutting tips, and/or electrodes. In some instances, a single torch body may be able to be used for a variety of cutting and/or welding operations (with different tips, electrodes, and/or other interchangeable components being interchangeably installed for different operations). However, in other instances, different torches may need to be used with specific interchangeable components for different cutting or welding operations. Unfortunately, either way, different torches and different interchangeable components (e.g., different torch tips and different electrodes) often require different operational settings. Thus, different torches and different interchangeable components (e.g., consumables, such as torch tips and/or electrodes) must be identified as they are installed in a torch and torches must be identified before they are connected to a power supply. Then, the torch and/or a power supply connected to the torch body usually need(s) to be adjusted for a specific torch being used with specific components.

Often, different torches and torch components (e.g., consumables, such as torch tips and/or electrodes) are identified via visual inspection and/or by scanning a bar code included on the component or packaging for the component. Unfortunately, visual or bar code identification is often difficult (if not impossible), especially for inexperienced users (especially for consumable components). Alternatively, some components may be identified using radio-frequency identification (RFID) techniques, pressure decay measurement techniques, and/or surface reflectivity measuring techniques. Unfortunately, RFID identification techniques may be expensive and may be incompatible with older parts unless the older parts are retrofitted with a RFID tag (rendering the technique even more expensive). Meanwhile, identifying components by measuring pressure decay or reflectivity may be unreliable and/or impractical for quickly identifying interchangeable components (e.g., consumables, such as torch tips and/or electrodes) as they are installed in a torch body. For example, pressure decay measurements may only be able to identify a component after a substantial amount of time and, moreover, measuring pressure decay for an electrode may be inaccurate if a tip orifice is worn. Meanwhile, measuring the reflectivity of a component may be unreliable since reflectively measurements may be inconsistent, especially for components of different shapes.

Regardless of how torches and/or interchangeable components are identified, the power supply usually needs to be manually adjusted to appropriate settings before a torch with a newly installed component can be used safely. In some instances, a user must consult industry literature (e.g., manuals) or the component's packaging to determine the appropriate settings, which may become quite tedious or confusing, especially for an inexperienced user. If, instead, a user adjusts the settings based on memory or does not adjust the settings, the torch may become unsafe to operate. Additionally or alternatively, the torch may operate under non-ideal conditions, which may negatively affect cutting/welding performance of the torch and/or decrease part life, each of which may create inefficiencies in the welding/cutting operations, in terms of both time and cost.

In view of the foregoing, it is desirable to quickly and automatically identify a torch and/or a torch component installed on the torch, including electrodes, torch tips, shield cups, gas distributors, or any other consumable, with accuracy and reliability. Moreover, it is desirable to automatically adjust cutting or welding parameters, such as power parameters, flow parameters, and/or fault conditions, based on the automatic identifying.

### SUMMARY

The present disclosure is directed towards automatically identifying torches and torch components, such as electrodes and torch tips, for welding and cutting systems. According to one embodiment, a luminescent material (e.g., a photoluminescent or electroluminescent material) that emits electromagnetic energy with a second spectral signature in response to absorbing electromagnetic energy with a first spectral signature is added to a surface of a torch and/or a torch component. Then, electromagnetic energy with the first spectral signature is directed at the surface(s) and the component(s) is/are automatically identified by detecting the electromagnetic energy with the second spectral signature as it is emitted from the surface. Luminescent materials, such as fluorescent materials, typically emit electromagnetic energy (e.g., fluoresce) consistently in response to absorbing electromagnetic energy with a specific spectral signature (e.g., light of a specific wavelength, be it visible or non-visible light), regardless of the angle of incidence of the electromagnetic energy on the component. Consequently, various torches and/or torch components can be reliably and consistently identified with the techniques presented herein.

Moreover, luminescent materials (e.g., fluorescent materials) are often relatively inexpensive as compared to various other parts identification solutions, such as RFID tags, and, thus, older parts can be easily and inexpensively retrofitted to be suitable with the identification techniques presented herein. Still further, since luminescent materials (e.g., fluorescent materials) may be configured to emit electromagnetic energy with a second spectral signature in response to electromagnetic energy with a first spectral signature, counterfeit or unsuitable parts can be easily identified (since counterfeit parts are unlikely to emit electromagnetic energy with the second spectral signature in response to absorbing electromagnetic energy with the first spectral signature). Counterfeit identification may reduce safety risks and performance degradation associated with counterfeit and/or unsuitable parts.

In some embodiments, operational parameters of an identified torch or a torch including an identified component (e.g., power parameters of power supplied to the torch), are automatically adjusted in response to the automatic identifying. For example, the power supply may automatically adjust an amperage of current supplied to the torch. Additionally or alternatively, an indication of operational parameters (e.g., current regulation) or a warning of unsafe conditions may be provided/generated at the power supply. Among other advantages, automatically adjusting operational parameters of the torch based on the automatic identifying allows a user to seamlessly transition from one cutting or welding operation to another cutting or welding operation.

For example, a user may seamlessly transition from cutting at 40 Amps with a first plasma cutting tip to cutting at 80 Amps with a second plasma cutting tip by swapping out the tips (and any other associated interchangeable torch components) without worrying about adjusting any settings at the power supply. As another example, a user may seamlessly transition from marking to cutting to gouging, etc. Moreover, and also advantageously, automatic adjustment of operational parameters may prevent a user from inadvertently or undesirably increasing or decreasing certain operational settings based on the electrodes or torch components currently installed in the torch. For example, the power supply may restrict the current of the supplied power to a specific upper limit based on an identity of a component or identities of components currently installed on the torch. Preventing a user from undesirably altering certain operational settings may discourage or prevent unsafe welding/cutting operations while also discouraging or preventing a user from cutting or welding with suboptimal operational settings. In turn, these benefits may decrease costs associated with the cutting/welding operation (i.e., by preventing errors and/or shortening the duration of operations) and decrease costs associated with cutting/welding operations over time, such as maintenance or replacement part costs (i.e., by extending the life of the torch, power supply, and/or consumable components).

According to another embodiment, automatic identification of components is effectuated by a torch including an electromagnetic energy source and an electromagnetic energy detector. The electromagnetic energy source generates electromagnetic energy with various spectral signatures (e.g., visible or non-visible light of various wavelengths) and transmits the electromagnetic energy to a luminescent (i.e., photoluminescent or electroluminescent) surface of an interchangeable torch component installed in an operating end of the torch. The electromagnetic energy detector detects electromagnetic energy emitted by the luminescent surface in response to the various spectral signatures of electromagnetic energy and identifies one or more of the spectral signatures that cause the luminescent surface to emit electromagnetic energy with a specific spectral signature (i.e., light with a particular amplitude). This allows the component to be identified automatically.

According to yet another embodiment, automatic identification of components is effectuated by a system including a torch, a power supply, and an electromagnetic energy detector. The electromagnetic energy detector (which may be included in the torch, the power supply, a lead between the torch and the power supply, or in any other location (e.g., a bolt-on detector can be coupled to the system in various locations)) detects a second electromagnetic energy emitted by a luminescent (i.e., photoluminescent or electroluminescent) surface of a component installed in/on the torch. The luminescent surface is configured to emit the second electromagnetic energy in response to absorbing a first electromagnetic energy with a specific spectral signature. The power supply automatically adjusts operational parameters of the torch based on the detection of the second electromagnetic energy. In at least some instances, the electromagnetic energy detector is disposed in the torch and the torch converts analog data from the electromagnetic energy detector into digital data and sends the digital data to the power supply. Additionally, the power supply may determine an identity of the component based on the digital data and adjust the operational parameters of the torch based on the identity.

According to still another embodiment, automatic identification of a torch is effectuated by a power supply including an electromagnetic energy source and an electromagnetic energy detector. The electromagnetic energy source generates electromagnetic energy with various spectral signatures (e.g., visible or non-visible light of various wavelengths) and transmits the electromagnetic energy to a luminescent (i.e., photoluminescent or electroluminescent) surface of the torch. The electromagnetic energy detector detects electromagnetic energy emitted by the luminescent surface in response to the various spectral signatures of electromagnetic energy and identifies one or more of the spectral signatures that cause the luminescent surface to emit electromagnetic energy with a specific spectral signature (i.e., light with a particular amplitude). This allows the torch to be identified automatically.

According to yet another embodiment, automatic identification of a torch is effectuated by a system including a torch, a power supply, and an electromagnetic energy detector. The electromagnetic energy detector (which may be included in the power supply, a lead between the torch and the power supply, or in any other location (e.g., a bolt-on detector can be coupled to the system in various locations)) detects a second electromagnetic energy emitted by a luminescent (i.e., photoluminescent or electroluminescent) surface of the torch. The luminescent surface is configured to emit the second electromagnetic energy in response to absorbing a first electromagnetic energy with a specific spectral signature. The power supply automatically adjusts operational parameters of the torch based on the detection of the second electromagnetic energy. Additionally, in some embodiments, the power supply may determine an identity of the torch based on the digital data and adjust the operational parameters of the torch based on the identity.

### BRIEF DESCRIPTION OF THE SEVERAL VIEWS OF THE DRAWINGS

FIG. 1 is a perspective view of a cutting system including a gas supply, a power source, and torch assembly that may implement the techniques of the present disclosure in accordance with at least one example embodiment.

FIG. 2A is a sectional view of an end of the torch of FIG. 1 when configured to receive automatically identifiable interchangeable torch components, according to an example embodiment of the present disclosure.

FIG. 2B is a side, partial sectional view of the power supply of FIG. 1, according to an example embodiment of the present disclosure.

FIG. 2C is a perspective view of the torch assembly of FIG. 1, according to an example embodiment of the present disclosure.

FIG. 3 is a block diagram of a torch and a power supply that are configured to automatically identify interchangeable torch components, according to an example embodiment of the present disclosure.

FIGS. 4A and 4B are high-level flow charts depicting operations for identifying torch assemblies and/or interchangeable components, such as consumable components, for torch assemblies, according to an example embodiment of the present disclosure.

FIG. 5 is a high-level flow chart depicting operations for identifying interchangeable components, such as consumable components, for welding and cutting torches, according to another example embodiment of the present disclosure.

FIG. 6 is a high-level flow chart depicting operations for identifying interchangeable components, such as consumable components, for welding and cutting torches, according to yet another example embodiment of the present disclosure.

Like numerals identify like components throughout the figures.

### DETAILED DESCRIPTION

A method, apparatus, and system for identifying welding and/or cutting torches (referred to herein simply as torches) and/or interchangeable torch components, such as electrodes and torch tips, for torches are presented herein. The method, apparatus, and system each measure the emission of electromagnetic energy from a luminescent surface of a torch or an interchangeable torch component to identify a component, insofar as a luminescent surface is a surface that can absorb and subsequently emit electromagnetic energy (as opposed to a surface that absorbs or reflects electromagnetic energy), such as a photoluminescent or electroluminescent surface. For example, the luminescent surface may be configured to emit electromagnetic energy with a second spectral signature in response to absorbing electromagnetic energy with a first spectral signature. In some embodiments, the luminescent material only emits electromagnetic energy in response to absorbing electromagnetic energy with a specific spectral signature. Thus, in some embodiments, any emission of electromagnetic energy by the luminescent surface may enable a torch or an interchangeable torch component on which the luminescent surface is included to be automatically identified. However, in other embodiments, the luminescent material emits electromagnetic energy in response to electromagnetic energy with a variety of spectral signatures, but only emits electromagnetic energy with the second spectral signature in response to absorbing electromagnetic energy with the first spectral signature. In these embodiments, a torch or an interchangeable torch component may be identified when its luminescent surface emits electromagnetic energy with a specific second spectral signature.

In some embodiments, torches and/or interchangeable torch components are manufactured with a luminescent surface. Alternatively, a luminescent material may be added to one or more surfaces of a torch and/or one or more interchangeable torch components in any desirable manner. Either way, since luminescent materials typically respond consistently to electromagnetic energy of a particular spectral signature—regardless of the angle of incidence of the electromagnetic energy on the surface—the torch and one or more interchangeable torch components can be quickly, reliably, and automatically identified. That is, torches and/or one or more interchangeable torch components can be quickly, reliably, and automatically identified because luminescent materials may consistently emit electromagnetic energy with a second spectral signature in response to absorbing electromagnetic energy with a first spectral signature.

As one specific example, a luminescent surface included on a torch or an interchangeable torch component may be a fluorescent surface that fluoresces when a specific wavelength of light or a specific range of wavelengths of light is directed at the surface. That is, the fluorescent surface may emit light in response to absorbing a specific wavelength or range of wavelengths of light (visible or non-visible light). The fluorescent surface may, in at least some embodiments, be created by adding (i.e., coating, painting, potting, etc.) fluorescent material to a surface of a torch and/or an interchangeable torch component. Meanwhile, a light detector (the specific embodiment including fluorescent may include a light detector while other embodiments may include electromagnetic energy detectors of any type) may detect light emitted by the fluorescent material included on a torch and/or an interchangeable torch component in response to various wavelengths of light being incident on the fluorescent material. The fluorescing (i.e., the emitted electromagnetic energy) can be detected by measuring the amplitude of light emitted from the fluorescent material.

As is explained in further detail below, in at least some embodiments, a power supply coupled to a torch receiving interchangeable torch components (e.g., interchangeable consumables) may automatically adjust or control operational parameters of the torch when one or more of the interchangeable torch components that are included in the torch are identified. For example, in some embodiments, the torch may be configured to emit light towards a fluorescent surface of a torch component, detect light emitted by the fluorescent surface, convert data relating to the detected light from analog data to digital data, and transmit the digital data to a power supply so that the power supply can identify the interchangeable torch component and automatically adjust or control operational parameters of the torch. Additionally or alternatively, a power supply may be configured to emit light towards a fluorescent surface of a torch, detect light emitted by the fluorescent surface, identify the interchangeable torch component, and automatically adjust or control operational parameters of the torch.

In embodiments where the torch emits and detects light and transfers data to the power supply to allow the power supply identify the component and automatically adjust power settings accordingly, the delegation of operations between the torch and the power supply may make the techniques presented herein easy to retrofit into existing torches. The delegation of operations may also, in some embodiments, reduce the amount of processing (and number of components) required in the torch which may make the torch easier to service, lighter (at least incrementally), and/or easier to operate. Moreover, identifying the component at the power supply may allow the power supply to quickly adjust the power parameters of power being delivered to the torch based on the components installed in the torch. This adjusting may ensure that the torch cannot operate with unsafe or undesirable power parameters, insofar as undesirable power parameters include power parameters that are undesirable for welding/cutting performance and/or for the longevity of the torch and/or the identified interchangeable (e.g., consumable) torch components.

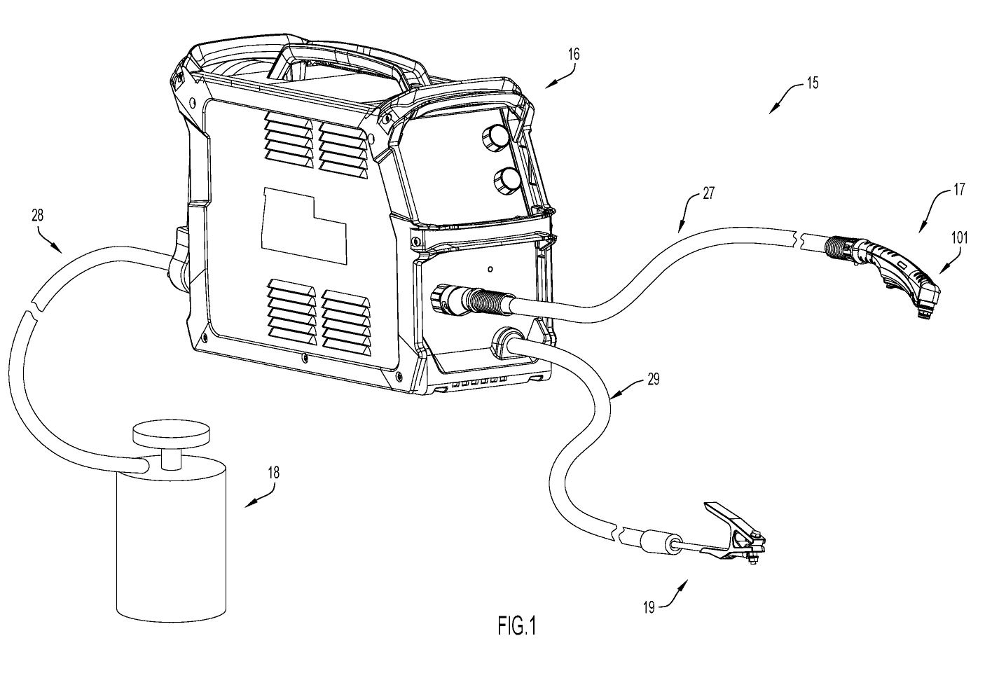

FIG. 1 illustrates an example embodiment of cutting system 15 that may utilize the techniques presented herein. However, the cutting system 15 is only depicted as an example of a cutting or welding system that may implement the techniques presented herein and, as mentioned above, the techniques presented herein can be implemented in any welding or cutting systems that utilize interchangeable components, such as interchangeable torches or interchangeable torch components. That being said, the depicted cutting system 15 includes a power supply 16 that supplies power to a torch assembly 17. The power supply 16 also controls the flow of gas from a gas supply 18 to the torch assembly 17 (however, in other embodiments, the power supply 16 might supply the gas itself). The gas supply 18 is connected to the power supply via cable hose 28 and the power supply 16 is connected to a torch 101 included in the torch assembly 17 via cable hose 27. The cutting system 15 also includes a working lead 29 with a grounding clamp 19.

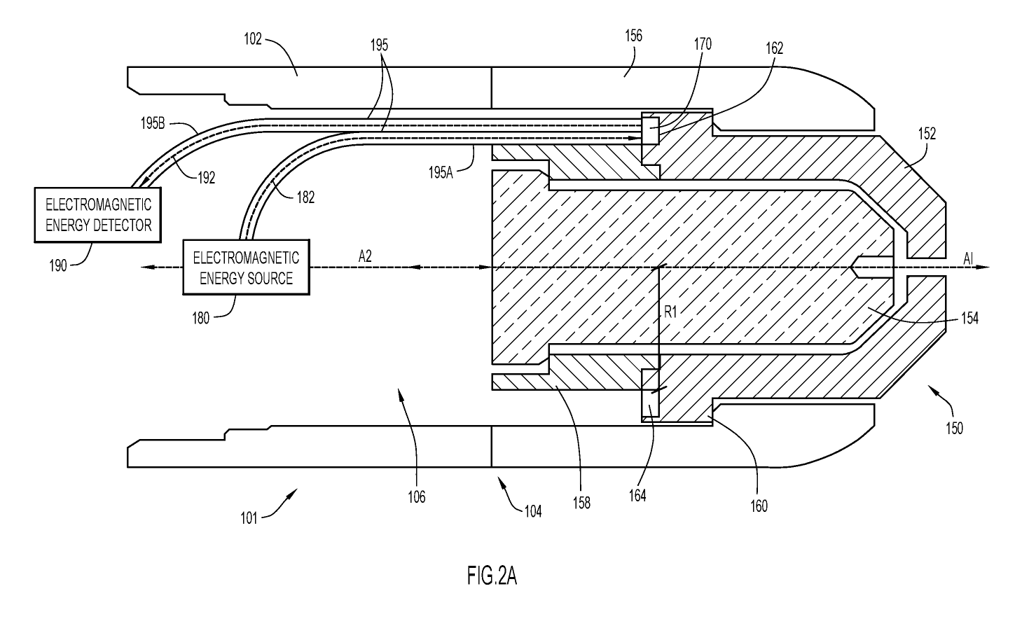

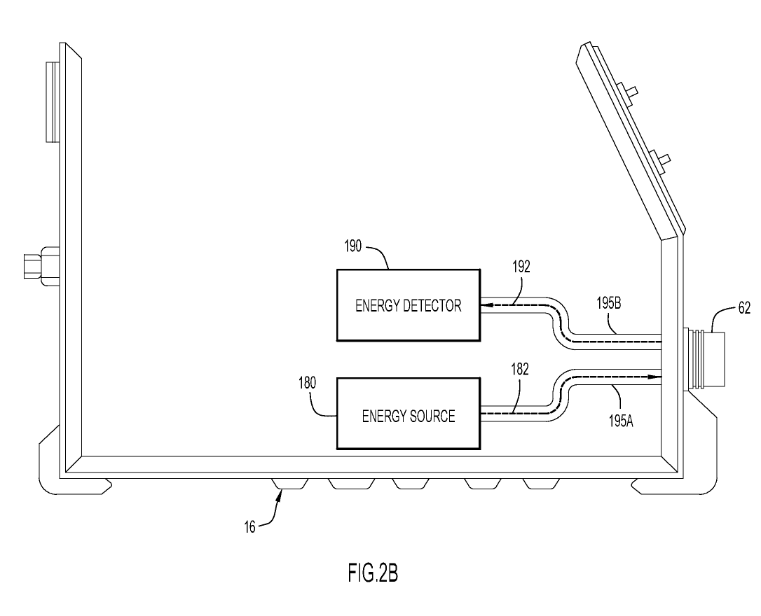

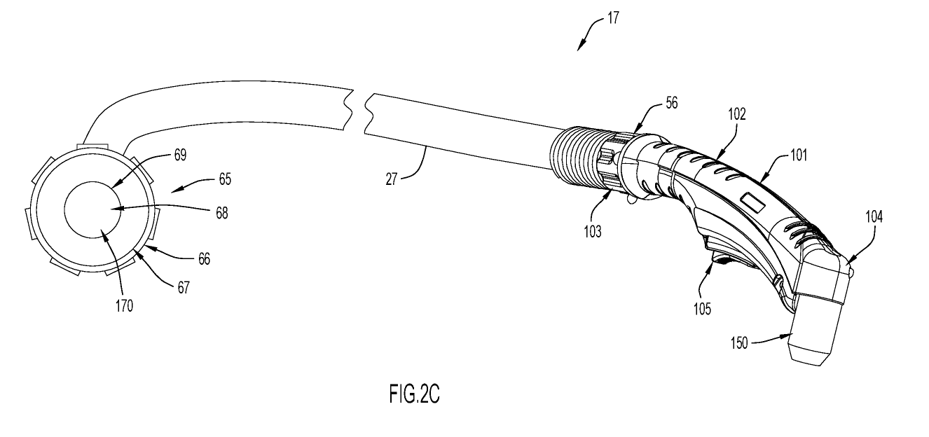

Cable hose 27, cable hose 28, and/or cable hose 29 may each include various conductors so that the cable hoses can transmit data, electricity, signals, etc. between components of the cutting system 15 (e.g., between the power supply 16 and the torch 101 of the torch assembly 17) and, as is illustrated, cable hose 27, cable hose 28, and/or cable hose 29 may each be any length. In order to connect the aforementioned components of cutting system 15, the opposing ends of cable hose 27, cable hose 28, and/or cable hose 29 may each be coupled to the power supply 16, torch 101, gas supply 18, or clamp 19 in any manner now known or developed hereafter (e.g., a releasable connection). As an example, the torch assembly 17 may include a connector 65 that releasably couples the cable hose 27 of the torch assembly 17 to a port 62 of the power supply 16 (see FIGS. 2B-2C) and may also include a connector 56 that releasably couples the torch 101 to the cable hose 27 (see FIG. 2C). Thus, the torch 101 may be releasably coupled to the power supply 16 via a releasable connection formed between the cable hose 27 and the power supply 16 and/or via a releasable connection formed between the cable hose 27 and the torch 101.

Now turning to FIGS. 2A-2C, generally, the techniques presented herein can identify a torch assembly of a welding or cutting system, such as torch assembly 17 (or the torch 101 included therein) and/or a consumable component installed in a torch of a welding or cutting system (illustrated generally at 150 in FIGS. 2A) when one or more of these components includes a luminescent surface 170. As mentioned, a component can be manufactured with the luminescent material included therein (e.g., with the material embedded within a depression), or the luminescent (e.g., fluorescent) material can be added to a surface of the component in any manner now known or developed hereafter for affixing luminescent (e.g., fluorescent) material to a metal or metal-like component, such as painting, potting, coating, deposition techniques, etc. Since at least some luminescent surfaces do not provide any indication of their presence (e.g., fluorescent materials may not reflect the same color that they fluoresce), it is possible to produce components with luminescent material that is undetectable and/or that does not give any indication of the specific energy (e.g., color of light) that it emits (e.g., fluoresces).

Irrespective of how the luminescent surface 170 is included on a portion of the torch assembly 17 and/or component 150, the luminescent (e.g., fluorescent) material is configured to emit electromagnetic energy in response to absorbing electromagnetic energy with at least one specific spectral signature (e.g., a specific wavelength). Thus, to identify a torch assembly 17 or component 150, the welding or cutting system (e.g., cutting system 15) may include one or more electromagnetic energy detectors and one or more electromagnetic energy source that are operably coupled to (e.g., optically aligned) with the luminescent surface 170 included on a torch assembly 17 and/or component 150. For example, the torch assembly 17 may include one or more electromagnetic energy sources 180 and one or more electromagnetic energy detectors 190 that are optically aligned with one or more luminescent surfaces 170 included on interchangeable torch components 150, as depicted in FIG. 2A. Additionally or alternatively, the power supply 16 may include one or more electromagnetic energy sources 180 and one or more electromagnetic energy detectors 190 (as shown in FIG. 2B) that are optically aligned with one or more luminescent surfaces 170 included on a torch assembly 17 (as shown in FIG. 2C). That is, one or more energy detectors and one or more sources/emitters may be included in the torch assembly 17 and/or the power supply 16 so that a cutting or welding system can identify a torch assembly 17 connected to a power supply 16 and/or interchangeable torch components installed in the torch assembly 17.

Regardless of where the one or more electromagnetic energy sources 180 and one or more electromagnetic energy detectors 190 are disposed, each electromagnetic energy source 180 may be any device or component capable of generating electromagnetic energy 182 with various spectral signatures. Additionally or alternatively, electromagnetic energy emitted during operations of the torch (i.e., light emitted by a plasma arc) may supplement or replace light from the electromagnetic energy source 180 included in or on the torch body 102 and, thus, the welding/cutting operations may also be referred to as the electromagnetic energy source. Meanwhile, the electromagnetic energy detector 190 may be any device or component that can detect energy 192 emitted from a luminescent surface and/or determine the spectral signature of emitted energy. As an example, if the luminescent surface 170 is a fluorescent surface, the electromagnetic energy source 180 may be a light source and/or a welding/cutting operation that generates light (visible and non-visible light) at a variety of wavelengths and the electromagnetic energy detector 190 may be a light detector that detects the amplitude and/or wavelength of light entering the detector.

Now turning to FIG. 2A, this Figure illustrates a portion of a torch 101 and, in a particular, a portion of a torch body 102 that is configured to receive interchangeable consumable torch components (generally referred to as components 150). For simplicity, FIG. 2A illustrates the torch body 102 without various components or parts, such as power or gas transfer components, that are typically included in a welding/cutting torch. Instead, FIG. 2A only illustrates select components or parts that allow for a clear and concise illustration of the techniques presented herein. However, it is to be understood that any unillustrated components that are typically included in a torch (i.e., components to facilitate welding or cutting operations) may and, in fact, should be included in a torch configured in accordance with an example embodiment of the present invention. Moreover, although FIG. 2A illustrates a luminescent surface 170 included on the torch tip 152, it is to be understood that this luminescent surface 170 is merely an example of a luminescent surface. Thus, in other embodiments, any interchangeable component 150 that is installable onto the torch body 102 (including interchangeable torch components shown in FIG. 2A as well as any other interchangeable torch components that are not shown in FIG. 2A) may include any type of luminescent surface 170.

That all being said, in the depicted embodiment, the torch body 102 receives an interchangeable electrode 154, an interchangeable torch tip 152, an interchangeable shield cup 156, and an interchangeable gas distributor 158, insofar as each of these consumable components may be interchangeable for other like consumable components and is not necessarily interchangeable or reconfigurable in and of itself. For example, the electrode 154 is interchangeable because it may be swapped for or replaced with another electrode. In the depicted embodiment, the gas distributor 158 and the electrode 154 can be installed into the torch body 102 and the tip 152 can be installed there over. Alternatively, the gas distributor 158, the electrode 154, and the tip 152 can be installed onto the torch body as a single component (e.g., these components may be coupled to each other to form a cartridge and installed on/in the torch body 102 as a cartridge).

Once the electrode 154 and the tip 152 are installed onto/into the torch body 102, the shield cup 156 is installed around an installation flange 160 of the torch tip 152 in order to secure the torch tip 152 and electrode 154 in place at (and in axial alignment with) an operating end 104 of the torch body 102. Additionally or alternatively, the torch tip 152 and/or electrode 154 can be secured or affixed to the torch body 102 in any desirable manner, such as by mating threaded sections included on the torch body 102 with corresponding threads included on the components. For example, in some embodiments, the electrode 154, the torch tip 152, the interchangeable shield cup 156, the interchangeable gas distributor 158, as well as any other components (e.g., a lock ring, spacer, secondary cap, etc.) may be assembled together in a cartridge that may can be selectively coupled to the torch body 102. For example, the various components may be coupled to a cartridge body or coupled to each other to form a cartridge. Moreover, in other embodiments, the torch 101 may include any suitable combination of interchangeable components 150, in addition to or in lieu of the interchangeable electrode 154, the interchangeable torch tip 152, the interchangeable shield cup 156, and/or the interchangeable gas distributor 158.

Regardless of how the gas distributor 158, the torch tip 152, the shield cup 156, and the electrode 154 are attached to the operating end 104 of the torch body 102, any of these interchangeable torch components 150, as well as any other interchangeable torch component 150 included in or on the torch body 102, can be identified when it includes a luminescent surface 170 (as mentioned above). To effectuate this, the torch body 102 depicted in FIG. 2A defines an interior cavity 106 that houses the electromagnetic energy source 180 and the electromagnetic energy detector 190. In other embodiments, the electromagnetic energy source 180 and/or the electromagnetic energy detector 190 need not be disposed within the interior cavity 106 of the torch body 102 and, instead, may be included on or adjacent the torch body 102 (e.g., the electromagnetic energy detector 190 may be a bolt-on detector). Regardless of their location, the electromagnetic energy detector 190 and the electromagnetic energy source 180 are operably coupled to interchangeable torch components 150 installed in/on the torch 17, insofar as the term “operably coupled” indicates that the electromagnetic energy source 180 and the electromagnetic energy detector 190 can transmit energy to and detect energy emitted from, respectively, a luminescent surface 170 included on that component.

In FIG. 2A, a base or rear surface 162 of an installation flange 160 of the torch tip 152 defines an annular depression 164 that is filled with, covered in. or otherwise includes luminescent material so as to define a luminescent surface 170. The electromagnetic energy source 180 and the electromagnetic energy detector 190 are operably coupled to this luminescent surface 170 via energy pathways 195 that extend to and from the luminescent surface 170, respectively. That is, a first energy pathway 195A extends from the electromagnetic energy source 180 to the luminescent surface 170 included on the interchangeable torch tip 152 and a second energy pathway 195B extends from the luminescent surface 170 included on the interchangeable torch tip 152 to the electromagnetic energy detector 190.

More specifically, in the particular embodiment depicted in FIG. 2A, the torch tip 152 is mounted within the torch body 102 so that its central axis A1 is coaxial with a central axis A2 of the operable end 104 of the torch body 102. Consequently, the annular depression 164 ensures that the luminescent material 170 is positioned at a certain radial distance R1 from the shared central axis A1, A2 of the torch tip 152 and the torch body 102 when the torch tip 152 is installed in the torch body 102. In view of this, the energy pathways 195 terminate at a location that is also the radial distance R1 from the central axis A2 of the torch body 102. This ensures that the energy pathways 195 are aligned with the luminescent material 170 included in the annular depression 164 as the torch tip 152 is installed in the torch body 102, regardless of the angular orientation of the torch tip 152 with respect to the torch body 102 during installation. Once the luminescent surface 170 is aligned with the energy pathways 195, the energy pathways 195 operably connect the electromagnetic energy source 180 and the electromagnetic energy detector 190 to the luminescent material 170, regardless of where the electromagnetic energy source 180 and the electromagnetic energy detector 190 are disposed with respect to the torch body 102. That is, the energy pathways 195 allow energy 182 emitted by the electromagnetic energy source 180 to transfer to the luminescent surface 170 and also allow energy 192 emitted by the luminescent surface 170 to travel to the electromagnetic energy detector 190.

As a more concrete example, if the luminescent surface 170 is a fluorescent surface, the energy pathways 195 may be light transmitters, such as fiber optics cables, that provide: (1) a first optical pathway 195A between a light source (the electromagnetic energy source 180 in this particular example) and the fluorescent surface 170; and (2) a second optical pathway 195B between the fluorescent material 170 and a light detector (the electromagnetic energy detector 190 in this particular embodiment). That being said, in other embodiments where the luminescent material 170 is a fluorescent material, the fluorescent material may be optically aligned, either directly (i.e., via a direct line-of-sight path) or via an optical assembly, with the light source 180 and the light detector 190 in any manner. Similarly, in various embodiments, any interchangeable torch component 150 can be installed on/in a torch body in any manner that operably couples (e.g., optically aligns) luminescent material included on that component with the electromagnetic energy source 180 and the electromagnetic energy detector 190 in any manner. For example, the component 150 and the torch 101 may include markings (or any other type of mechanical keying method) that indicate how to align the component 150 and torch body 102 during installation of the component 150 to ensure the luminescent material 170 is operably coupled to the electromagnetic energy source 180 and the electromagnetic energy detector 190.

Still referring to FIG. 2A, in the depicted embodiment, only the torch tip 152 includes a surface with luminescent material 170 and, thus, the electromagnetic energy detector 190 only detects energy emitted from the luminescent material 170 included on the torch tip 152. Then, the component may be identified in the manner described in detail below in connection with FIGS. 2-4. As mentioned, in other embodiments, the torch tip 152, the electrode 154, a cartridge including some combination of consumable components and/or any other interchangeable components 150, including any other consumable components, may also include luminescent material 170. In these embodiments, the electromagnetic energy source 180 and the electromagnetic energy detector 190 may be configured to transmit electromagnetic energy 182 to and detect electromagnetic energy 192 emitted from, respectively, any luminescent material 170 included on any interchangeable component or combination of components 150 installed on the torch body 102. That is, the description of the torch tip 152 included above may apply to another consumable component or combination of consumable components (e.g., a cartridge).

For example, the rear surface of any consumable component may include a similar annular depression with luminescent material or define any other type of luminescent surface. Additionally, combinations of consumables may form or include at least one luminescent surface. For example, a consumable cartridge may include a luminescent surface that identifies each of the components included in the cartridge. Still further, in some embodiments, consumables configured to build or otherwise be included in a consumable cartridge might each have a luminescent surface and the luminescent surfaces of the components included in a cartridge may be identifiable individually or as a group. That is, in some embodiments, components of a cartridge might be assembled in a manner that allows the various components to collectively define a luminescent surface that allows identification of the cartridge. Meanwhile, in other embodiments, one part or component of a cartridge may have a luminescent surface that identifies the cartridge and/or each component of a cartridge may have a luminescent surface that, upon identification, indicates that the component is included in the cartridge.

If the electromagnetic energy source 180 transmits electromagnetic energy 182 to luminescent surfaces 170 included on two or more interchangeable torch components 150, the torch body 102 may define separate energy pathways 195B from the two or more components to the electromagnetic energy detector 190 and/or the torch body 102 may include multiple electromagnetic energy detectors 190. This may allow a processor associated with the electromagnetic energy detector 190 can determine which component to identify. For example, a first electromagnetic energy detector 190 may be associated with the torch tip 152 and a second electromagnetic energy detector 190 may be associated with the electrode 154.

In fact, in some embodiments, the torch body 102 may include any number of distinct energy pathways 195, for example, to accommodate multiple electromagnetic energy sources 180 (which may, for example, transmit light to fluorescent material at different specific wavelengths) and/or multiple electromagnetic energy detectors 190 (which may each detect the amplitude of light emitted from a particular surface). Still further, in some embodiments, one electromagnetic energy detector 190 may detect emitted energy from multiple components 150 (along one or more pathways 195), but the one electromagnetic energy detector 190 may be able to identify specific spectral signatures associated with different types of interchangeable components 150. Thus, a single electromagnetic energy detector 190 may be able to identify combinations of interchangeable torch components 150.

Now turning to FIGS. 2B and 2C, as mentioned, in some embodiments, the cutting or welding system 15 may utilize one or more luminescent surfaces 170 to identify a torch assembly 17, either in addition to or instead of utilizing utilize one or more luminescent surfaces 170 to identify torch components installed in a torch assembly 17. The torch assembly 17 may identified in largely the same manner as interchangeable components 150, except that the various components involved in emitting and detecting energy may be required to be located in different locations. Thus, any description included herein relating to identifying an interchangeable torch component 150 based on luminescent surface 170 included or defined on the interchangeable torch component 150 should also be understood to apply to identifying a torch assembly 17 based on luminescent surface 170. Consequently, only the locations of the luminescent surfaces 170, the energy source 180, and the energy detector 180 shown in the example configuration that may be suitable for identifying a torch assembly 17 are described below.

With that in mind, in FIGS. 2B, the power supply 16 defines an interior cavity 61 that houses the electromagnetic energy source 180 and the electromagnetic energy detector 190. In other embodiments, the electromagnetic energy source 180 and/or the electromagnetic energy detector 190 need not be disposed within the interior cavity 61 of the power supply 16 and, instead, may be included on or adjacent the power supply 16 (e.g., the electromagnetic energy detector 190 may be a bolt-on detector). Regardless of their location, the electromagnetic energy detector 190 and the electromagnetic energy source 180 are operably coupled to a port 62 on which a cable hose 27 included in or connected to a torch assembly 17 may be coupled.

As can be seen in FIG. 2C, in the depicted example, the torch assembly 17 includes a torch 101 with a torch body 102 that extends from the operative end 104 (e.g., a second end 104) to a first end 103 (e.g., a connection end 103). As is discussed above, the operative end 102 of the torch body may receive interchangeable components, such as consumable components, which are generally denoted by item 150, but may include a variety of components, such as torch tips, electrodes, gas rings, etc. Meanwhile, the connection end 103 of the torch body 102 may be coupled (in any manner now known or developed hereafter) to one end of lead 27. The other end of lead 27 may be coupled to or include a connector 65 that allows the torch assembly 17 to be coupled to the port 62 of the power supply 16 in any manner now known or developed hereafter (e.g., a releasable connection). The body 102 may also include a trigger 105 that allows a user to initiate cutting operations.

In the embodiment depicted in FIG. 2C, the connector 65 includes mounting feature 69 and a locking ring 66. The mounting feature 69 is a plug-type mounting feature 69 and a base or rear surface 68 of a plug-type mounting feature 69 includes or defines a luminescent surface 170. Thus, when the mounting feature 69 is inserted into the port 62, the electromagnetic energy source 180 and the electromagnetic energy detector 190 are operably coupled to this luminescent surface 170 via energy pathways 195 that extend through the power supply, to and from the luminescent surface 170, respectively. That is, a first energy pathway 195A extends from the electromagnetic energy source 180 to the luminescent surface 170 included on the connector 65 and a second energy pathway 195B extends from the luminescent surface 170 included on the connector 65 to the electromagnetic energy detector 190.

After the plug-type mounting feature 69 is inserted into the port 62, the locking ring 66 can secure the connector 65 to the port 62 (e.g., via threaded connections). Moreover, in some embodiments, a rear surface 66 of a locking ring 67 can include or define a luminescent surface 170 (in addition to or in lieu of the rear surface 68 of the plug-type mounting feature 69). Still further, in some embodiments, a surface of the connector 56 could include or define a luminescent surface 170 (in addition to or in lieu of a luminescent surface 170 of connector 65). In these embodiments, energy pathways (e.g., fiber optic cables) might extend through the cable hose 27 to operably couple the luminescent surface 170 of the connector 56 to one or more electromagnetic energy sources 180 and one or more electromagnetic energy detector 190 disposed in power supply 16.

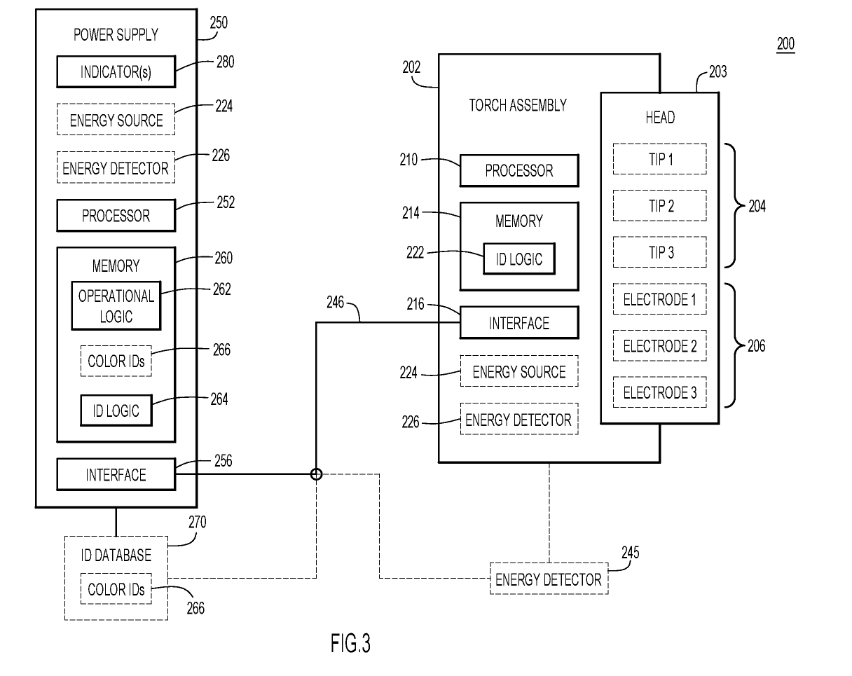

Now turning to FIG. 3, this Figure depicts a high-level block diagram of a system 200 configured in accordance with the present invention. The system 200 includes a torch 202 (such as the torch 101 depicted in FIGS. 2A and 2C) and a power supply 250 that is configured to adjust operational parameters, such as power parameters, of the torch 202 (such as the power supply 16 depicted in FIGS. 1 and 2B). In some embodiments, the system 200 may also include an external energy detector 245 (e.g., the electromagnetic energy detector 190 depicted in FIG. 2A and/or 2B may be a bolt-on detector or a detector included on a lead 246 between the torch 202 and the power supply 250 (such as lead 27)).

As was described above in connection with FIGS. 2A-2C, the torch 202 may include a head 203 that can selectively receive interchangeable consumables, such as torch tips 204 and/or electrodes 206. Consequently, tips 1-3 and electrodes 1-3 are shown in dashed lines as possibly being installed on the head 203 of torch 202. The torch 202 also includes a processor 210, memory 212, and an interface 216 that provides a connection to an interface 256 included in the power supply 250 and/or an external detector 245. In some embodiments, the interface 216 included in the torch 202 may provide a power and data connection to the power supply 250 (i.e., via separate transmission cables). For example, interface 216 and interface 246 may each include a wireless interface unit and a and a power interface unit, with the wireless interface unit enabling wireless data transfer between the torch and the power supply and the power interface unit that enabling wired power to transfer from the power supply to the torch. Alternatively, the wired interface unit may enable both power and data connections.

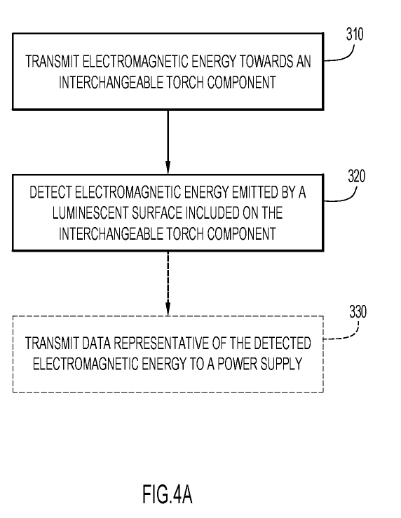

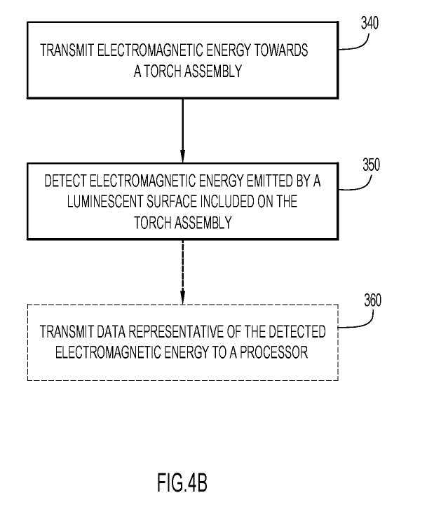

The processor 210 included in the torch 202 (i.e., a microprocessor) may execute instructions included in memory 214 (i.e., identification (ID) logic 222) in order to operate various components included therein or coupled thereto. For example, in embodiments where an electromagnetic energy detector and an electromagnetic energy source are disposed in, on, or adjacent the torch assembly 202,the processor 210 may execute ID logic 222 to operate the electromagnetic energy detector (e.g., energy detector 226 or energy detector 245) and the electromagnetic energy source (e.g., energy source 224). In these embodiments, the processor 210 may also execute ID logic 222 to send data to the power supply 250, as is discussed in further in detail in connection with FIG. 4A. Moreover, in some embodiments, the torch 202 may execute the ID logic 222 to identify a component installed therein (e.g., one of electros 2026 or one of tips 204).

Meanwhile, the power supply 250 may also include a processor 252 configured to execute instructions stored in its memory 260 (i.e., operational logic 262 and ID logic 264). For example, in embodiments where an electromagnetic energy detector and an electromagnetic energy source are disposed in, on, or adjacent the power supply 250, the processor 252 may execute ID logic 264 to operate the electromagnetic energy detector (e.g., energy detector 226 or energy detector 245) and the electromagnetic energy source (e.g., energy source 224), as is discussed in further in detail in connection with FIG. 4B. Since, as mentioned above, the electromagnetic energy detector and an electromagnetic energy source may be included in only the power source, only the torch assembly, or both, FIG. 3 depicts the electromagnetic energy detector 226 and an electromagnetic energy source 226 in dashed lines.

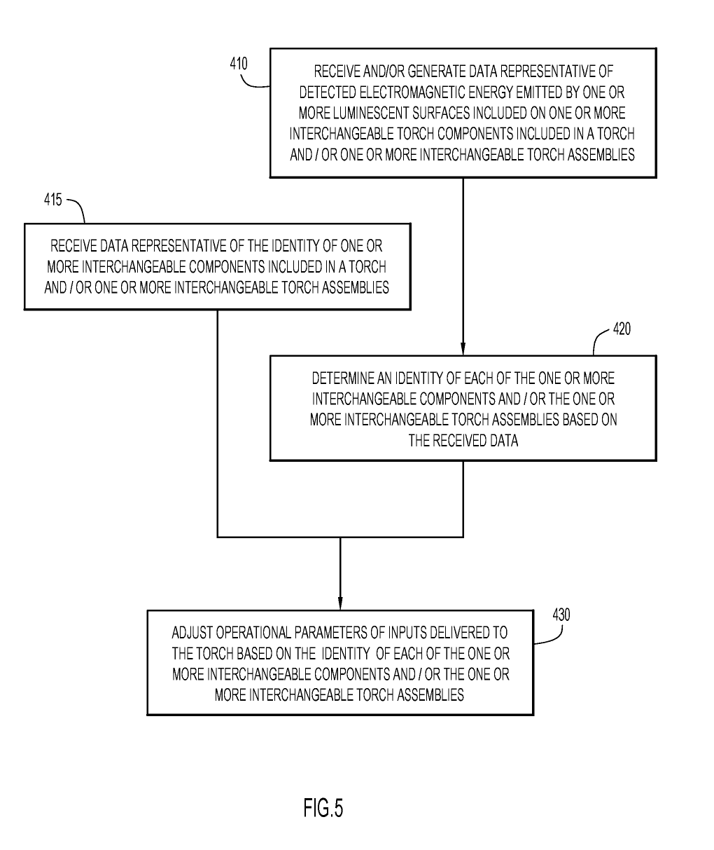

The memory 260 of the power supply 250 may also store a color ID data structure 266 (i.e., a table) that correlates data received from the torch 202 and/or an external energy detector 245 with component identities. Alternatively, the color ID data structure 266 can be stored in an external ID database 270 that may be accessed by the power supply 250 and/or torch 202 (i.e., through a network interface unit included in the interface 256). As is described in further detail below in connection with FIGS. 4 and 5, in at least some embodiments, the power supply processor 252 may execute the ID logic 264 to correlate data received from the torch 202 with a component identity to identify an installed component. Additionally or alternatively, the power supply processor 252 may execute the operational logic 262 to adjust the operational parameters, such as the power parameters, of the torch 202 while an identified component is included in the torch 202.

Generally, the memory 214 included in the torch 202 and/or the memory 260 included in the power supply 250 may be configured to store data, including instructions related to operating various components or any other data. Moreover, the memory 214 included in the torch 202 and/or the memory 260 included in the power supply 250 may include read only memory (ROM), random access memory (RAM), magnetic disk storage media devices, optical storage media devices, flash memory devices, electrical, optical or other physical/tangible (e.g., non-transitory) memory storage devices. Thus, in general, the memory 214 included in the torch 202 and/or the memory 260 included in the power supply 250 may be or include one or more tangible (non-transitory) computer readable storage media (e.g., a memory device) encoded with software comprising computer executable instructions. For example, memory 214 and/or memory 260 may store instructions that may be executed by its associated processor 210, 252 for automatically identifying a component installed in/on a torch 202 and/or automatically adjusting operational parameters in response to identifying a consumable component, as described herein. In other words, the memory 214 included in the torch 202 and/or the memory 260 included in the power supply 250 may include instructions, that when executed by one or more processors (e.g., processor 210 or processor 252), cause the one or more processors to carry out the operations described herein.

Still referring to FIG. 3, the power supply 250 may also include an indicator or indicators 280. In some instances, the indicator(s) 280 include a current gauge, pressure gauge, fault gauge, and/or other operational control signals. Additionally or alternatively, the indicator(s) 280 may be a display that can display the identity of currently identified components and/or display warnings when a user attempts to change power settings to unsafe settings.

As mentioned, FIG. 4A illustrates a high-level flow chart of the operations performed by a torch that is operable to control an electromagnetic energy detector and an electromagnetic energy source included therein/thereon, such as the torch of FIG. 2A/2C or FIG. 3, in accordance with an example embodiment. Initially, at 310, the electromagnetic energy source of the torch transmits electromagnetic energy towards one or more interchangeable torch components installed in/on the torch, such as an interchangeable consumable component or interchangeable consumable cartridge. More specifically, the electromagnetic energy source transmits electromagnetic energy with various spectral signatures towards a luminescent material included on one or more components installed in the torch (i.e., based on instructions from the processor). For example, the electromagnetic energy source may be a light source that transmits light towards a fluorescent surface at various wavelength intervals.

Naturally, the luminescent material absorbs some energy from the electromagnetic energy and emits the remaining energy (e.g., as light at a different wavelength). In at least some embodiments, the particular luminescent material included on the identifiable interchangeable torch components is configured to only emit electromagnetic energy (e.g., fluoresce) when the electromagnetic energy source transmits electromagnetic energy that has a specific spectral signature or is within a specific range of spectral signatures onto the luminescent material. Alternatively, the luminescent material included on one or more identifiable interchangeable torch components may be configured to emit electromagnetic energy (e.g., fluoresce) with a specific spectral signature only when the electromagnetic energy source transmits electromagnetic energy that has a specific spectral signature or is within a specific range of spectral signatures onto the luminescent material. For example, a fluorescent material may be configured to only fluoresce or fluoresce brightest in response to a specific wavelength or range of wavelengths.

Consequently, at 310 the electromagnetic energy source transmits electromagnetic energy with various spectral signatures (e.g., light with wavelengths A, B, C, and D) onto the luminescent material in order to try to cause the luminescent material to emit at least some electromagnetic energy or to emit electromagnetic energy with a specific spectral signature. Still further, in some embodiments, the electromagnetic energy source may transmit electromagnetic energy with various spectral signatures (e.g., light with wavelengths A, B, C, and D) onto the luminescent material in order to try to cause luminescent material included on multiple components to emit a specific combination of spectral signatures.

If the electromagnetic energy source transmits electromagnetic energy to the luminescent material that causes the luminescent material to emit energy, the detector will detect the emitted electromagnetic energy at 320 (e.g., the detector may detect fluoresced light). More specifically, the detector will detect a spectral signature of any electromagnetic energy emitted from the luminescent material and transferred to the electromagnetic energy detector (e.g., based on instructions from the processor). For example, if the luminescent material is a fluorescent material, the detector may measure an amplitude of light emitted by fluorescent material in response to wavelengths A, B, C, and D from the light source being incident on the fluorescent material. In this scenario, the highest amplitude measurement may indicate that the fluorescent material was fluorescing. For example, if the detector measure an amplitude of 1 for wavelength A, an amplitude of 3 for wavelength B, an amplitude of 10 for wavelength C, and an amplitude of 2 for wavelength D, the detector may detect light emission in response to wavelength C (since the amplitude of emitted light is the highest in response to wavelength C). That is, the detector may determine that the component including the fluorescent material can be identified based on wavelength C.

In at least some embodiments, the torch transmits data to the power supply that is indicative of the detected electromagnetic energy at 330. For example, at 330, the torch may transmit data that is indicative of the highest measured amplitude. In these embodiments, the torch may also convert the data recorded by the detector from analog data to digital data before transmitting the data so that, for example, the torch transmits data that indicates the detector has detected a particular color when a particular wavelength is transmitted to the fluorescent material. As a more specific example, if the detector measures an amplitude of 10 for wavelength C as discussed above, the torch may convert the data value of 10 into a specific color (i.e., “blue”) and transmit the color to the power supply. However, the torch need not transfer digital data representative of detected emitted light in all embodiments. Instead, in some embodiments the torch may identify the component itself (i.e., by consulting an external ID data structure) and transfer an identity of the component to the power supply. Consequently, step 330 is shown in dashed lines.

Moreover, although FIG. 4A illustrates an embodiment where the electromagnetic energy source and detector are included in the torch, in some embodiments, at least the detector may be external to the torch, as illustrated by detector 245 in FIG. 3. In these embodiments, the torch processor may gather information from an external detector or provide the external detector with instructions to transmit gathered data to the power source. That is, in at least some embodiments, at step 320, the torch may gather information from an external detector (e.g., a detector disposed in the power supply or on a lead between the torch and the power supply) that is detecting emitted electromagnetic energy. Alternatively, step 320 may be performed by the power source if the power source includes the detector, thereby rendering step 330 redundant (similar to how step 330 may be redundant in embodiments where the torch determines the identity of the component).

FIG. 4B is substantially similar to FIG. 4A, except that FIG. 4B illustrates a high-level flow chart of the operations performed by a power supply (as opposed to a torch) that is operable to control an electromagnetic energy detector and an electromagnetic energy source included therein/thereon, such as the power supply of FIG. 2B or FIG. 3, in accordance with an example embodiment. Thus, any description included herein relating to identifying an interchangeable torch component 150 based on luminescent surface 170 included or defined on the interchangeable torch component 150 should also be understood to apply to identifying a torch assembly 17 based on luminescent surface 170.

For example, initially, at 340, the electromagnetic energy source of the power supply transmits electromagnetic energy towards a torch assembly connected to the power supply and any description included above relating to transmitting the electromagnetic energy source transmits electromagnetic energy with various spectral signatures towards a luminescent material included on one or more components installed in the torch should be understood to apply to the transmission that occurs at 340. Similarly, if the power supply's electromagnetic energy source transmits electromagnetic energy to luminescent material on the torch assembly (e.g., luminescent material on connector 65) that causes the luminescent material to emit energy, the detector in the power supply will detect, at 350, any electromagnetic energy emitted by the luminescent surface (e.g., the detector may detect fluoresced light) in the same manner that electromagnetic energy is detected by a detector included in the torch assembly at 320. For example, in some embodiments, the detector can be external to the power supply, similar to how the detector may be external to the torch (as is described above in connection with FIG. 4A).

Notably, since the electromagnetic energy source and the electromagnetic energy detector are disposed in power supply, this embodiment need not transmit data to the power supply. Instead, at 360, the electromagnetic energy source and/or the electromagnetic energy detector may transmit data to a processor to allow the processor to identify the torch assembly, similar to how the torch may transmit data to the power supply at 330. The processor may be internal or external to the power supply.

FIG. 5 depicts a high-level flow chart of the operations of the power supply configured in accordance with an example embodiment. Initially, at 410, the power supply generates and/or receives data from the torch. More specifically, at 410, the power supply may receive data representative of electromagnetic energy emitted by one or more luminescent surfaces included on one or more interchangeable torch components. Additionally or alternatively, an electromagnetic energy source and an electromagnetic energy detector disposed in the power supply may generate data representative of electromagnetic energy emitted by one or more luminescent surfaces included on a torch assembly physically connected to the power supply. For example, the power supply may receive digital data indicating a color emitted by a fluorescent surface included on an interchangeable torch tip. As another example, the power supply may receive data (analog or digital) that indicates the electromagnetic energy emitted from multiple interchangeable torch components has a specific combination of spectral signatures. As yet another example, the power supply may generate digital data indicating a color emitted by a fluorescent surface included on a connector of a torch assembly.

In addition to or instead of receiving/generating data at 410, the power supply may receive data representative of the identity of one or more interchangeable components included in a torch at 415. For example, the torch may identify a torch tip as a 40 Amp cutting tip and send data indicative of this identification to the power supply. Notably, in embodiments configured to detect combinations of interchangeable components, one or more detectors may send data to the power supply so that, the power supply is receiving data from multiple sources at 410 and/or 415. For example, a electromagnetic energy detector disposed in the power supply may generate data representative of electromagnetic energy emitted by one or more luminescent surfaces included on a connector of a torch assembly physically connected to the power supply while the power supply receives data representative of electromagnetic energy emitted by one or more luminescent surfaces included on interchangeable torch components from the torch. Alternatively, the torch may include multiple detectors, each configured to detect energy emitted by a specific type of consumable and the power supply may receive data generated by each of these detectors.

If the power supply receives/generates data representative of detected electromagnetic energy emitted by one or more luminescent surfaces at 410 (as opposed to receiving one or more identities at 415), the power supply (i.e., the processor of the power supply) determines an identity of the of the torch components and/or the torch assembly based on the received data at 420. For example, if the luminescent surface is a fluorescent surface, the data received at 410 may be a color and the power supply may correlate this color with a particular component or assembly. As a more specific example, if the data is “red” this may indicate that the torch tip currently installed in the torch is a 60 Amp cutting tip for a plasma cutting torch. Alternatively, “blue” may indicate that the torch tip currently installed in the torch is a gouging tip for a plasma cutting torch and “yellow” may indicate that the torch tip currently installed in the torch tip is a 40 Amp cutting tip for a plasma cutting torch.

If at 415 or 420 that power supply does not receive an identity or is unable to determine an identity, respectively, the power supply may determine that a torch components and/or torch assembly is incompatible with the cutting or welding system. For example, a torch tip that is unidentified may be determined to be incompatible with a torch, be it a plasma cutting torch, a welding torch, or any other torch (the plasma tips mentioned above are merely examples, and the techniques presented herein may identify any components for any torch type). For example, if an embodiment includes a detector that is configured to detect light emissions from a fluorescent surface and the data received at 410 indicates that a color cannot be ascertained when monitoring emissions from a particular interchangeable torch component, the power supply may determine that the interchangeable torch component is incompatible with the torch body.

At 430, the power supply adjusts the operational parameters of the torch based on the identity of the torch components and/or the torch assembly determined at 420. For example, following the examples used above, if the torch tip is identified as a 60 Amp or 40 Amp cutting tip for a plasma cutting torch (red and yellow, respectively), the power supply may adjust the power delivery so that 60 Amps or 40 Amps of current are delivered to the torch, respectively. Moreover, if the power supply detects that a user is attempting to change the current to 100 A when the power supply has determined that the 60 Amp or 40 Amp torch tip is installed on the torch tip (or when a 60 Amp or 40 Amp torch assembly is attached to the power supply), the power supply may automatically roll the current back to a safe level (i.e., to 60 or 40 Amps). That is, in some instances, the techniques may not prevent arc initiation, but will ensure arc transfer is effectuated with optimal operational parameters (to ensure safety and high quality operations). Alternatively, if a torch tip is identified as a gouging tip, the power supply may be set to a gouging mode and if the torch tip is unidentified, the power supply may prevent arc transfer to a work piece. This may prevent counterfeit or unsuitable/undesirable components from being used with (and possibly damaging) the torch body.

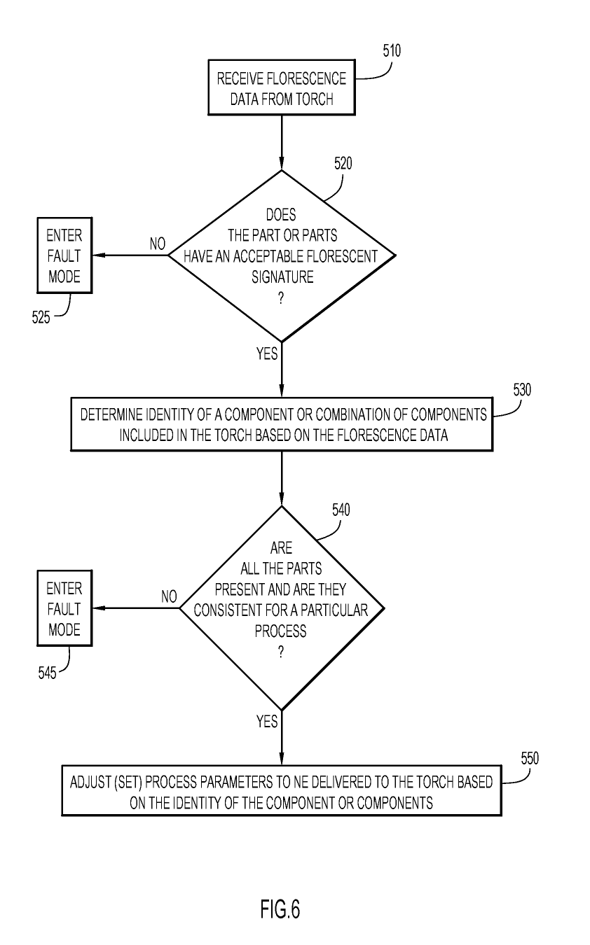

Now turning to FIG. 6, this Figure depicts another high-level flow chart of the operations of a power supply configured in accordance with another example embodiment. In FIG. 6, operations of the power supply are discussed with respect to an embodiment where the luminescent surface is a fluorescent surface that absorbs and emits light; however, it is to be understood that this is merely an example and, in other embodiments, the operations may be adjusted accordingly for any type of electromagnetic energy. Additionally, the operations depicted in FIG. 6 are discussed with respect to an embodiment where the power supply receives data from a torch (e.g., an embodiment where the energy source and detector are disposed in the torch); however, it is to be understood that this is merely an example and, in other embodiments, the operations may be adjusted for a power supply that includes the energy source and detector and generates data based on energy emitted by a luminescent surface of a torch assembly.

That being said, in FIG. 6, the power supply initially receives fluorescence data from the torch at 510. As has been discussed herein, the data may be digital data representative of a color or identity and/or analog data indicating an amplitude of detected light. Alternatively, the data may include one or more identities for interchangeable torch components currently installed in the torch. Either way, at 520, the power supply may determine if the one or more interchangeable torch components from which emitted light has been detected are genuine and/or suitable for the particular torch. That is, at 520, the power supply may determine if the one or more the one or more interchangeable torch components have emitted light with a recognizable fluorescent signature.

If the parts are determined to be genuine at 520 (i.e., suitable for the torch body and not counterfeit), the power supply may the determine identities for any identifiable interchangeable torch components currently installed in the torch body at 530. At 540, the power supply then determines whether the identified interchangeable torch components are consistent or compatible for a particular cutting/welding operation. To make this determination, the power supply may determine if multiple identified interchangeable torch components can or should be used together and/or if one or more identified interchangeable torch components are suitable for a selected welding/cutting operations. For example, the power supply may determine if an electrode, a torch tip, a gas distributor, and a shield cup currently installed in a torch body are all suitable for 100 Amp air/air cutting.

If, instead, at 520 the power supply determines that one or more parts are not genuine and/or unsuitable for the particular torch (i.e., one or more parts are counterfeit), the power supply may enter a fault mode at 525. Similarly, if, at 540, the power supply determines that at least one of the identified interchangeable torch components is incompatible with other identified interchangeable torch components (i.e., one interchangeable torch component is not suitable for 100 Amp air/air cutting) the power supply may enter a fault mode at 545. When the power supply is operating in fault mode, it may prevent operations of the torch. Alternatively, in fault mode, the power supply may limit operations of the torch to operations that will not experience a degradation in quality and/or become unsafe when operating with the identified interchangeable torch components. By comparison, if the power supply determines that the identified interchangeable torch components are compatible with each other and/or suitable for a particular cutting/welding operation, the power supply may atomically adjust, at 550, process parameters (i.e., operational parameters) to be delivered to the troch based on the identity of the component or components. That is, the power supply (or the torch) may determine that identified components are all intended to be used for a particular operation and the power supply may adjust operational parameters of the torch to support the particular operation.

Among other advantages, the techniques described and shown herein allow a user to quickly and seamlessly transition between various cutting and welding operations. The techniques presented herein also provide increased safety and better operating conditions for welding and cutting operations by automatically configuring operational parameters (e.g., power parameters) for the specific components currently installed on a torch. Consequently, inexperienced and experienced users alike need not know (or even try to find) the particular settings for every component and need not even identify components as they install them into a welding or cutting system. Moreover, even if a user tries to use an unsafe or suboptimal setting, the techniques presented herein may prevent the user from doing so.

As still further examples, the techniques presented herein may inexpensively and reliably identify interchangeable torch components as well as interchangeable torch assemblies. That is, at least as compared to adding electrical components to a torch component, adding luminescent (e.g., fluorescent) material to torch components and/or torch assemblies may be considerably cheaper and at least as reliable. Moreover, since the techniques presented herein do not add additional electrical components to a consumable, the techniques do not necessarily require an additional electrical connection to be added between the power supply and the torch to support/read this additional electrical component.

To summarize, in one form, the present disclosure is directed to a torch for welding or cutting operations includes an electromagnetic energy source and an electromagnetic energy detector. The electromagnetic energy source generates first electromagnetic energy with various spectral signatures and directs the first electromagnetic energy to a luminescent surface of an interchangeable torch component installed in an operating end of the torch. The electromagnetic energy detector detects second electromagnetic energy emitted by the luminescent surface in response to absorbing at least some of the first electromagnetic energy so that the interchangeable torch component can be identified.

In at least some of these embodiments, the interchangeable torch component is one or more consumable components. For example, the one or more consumable components may include at least one of: an electrode, a torch tip, a shield cup, and a gas distributor (insofar as this terminology indicates that a consumable component may include any of these components individually or any of these components in combination with any of the other components, and does not require that that the consumable include at least one of each). Additionally or alternatively, the luminescent surface of the interchangeable torch component may be a photoluminescent surface or an electroluminescent surface. For example, the luminescent surface may be a fluorescent surface. In these embodiments, the first electromagnetic energy with various spectral signatures comprises visible or non-visible light of various wavelengths and the second electromagnetic energy emitted by the luminescent surface is fluoresced light.

In some embodiment of the above torch, the torch also includes a torch body that defines the operating end of the torch and the interchangeable torch component is removably securable to the torch body in a manner that operably couples the luminescent surface to the electromagnetic energy source and the electromagnetic energy detector.

Additionally or alternatively, the interchangeable torch component may be a first interchangeable torch component, the luminescent surface is a first luminescent surface, and the electromagnetic energy source may direct the first electromagnetic energy to the first luminescent surface of the first interchangeable torch component and also directs the electromagnetic energy to a second luminescent surface of a second interchangeable torch component installed in an operating end of the torch. In these instances, the electromagnetic energy detector detects the second electromagnetic energy emitted by the first luminescent surface of the first interchangeable torch component and also detects third electromagnetic energy emitted by the second luminescent surface of the second interchangeable torch component in response to absorbing at least some of the first electromagnetic energy with the various spectral signatures. This allows the first interchangeable torch component and the second interchangeable torch can be identified. In some of these embodiments, the electromagnetic energy detector includes a first detector optically aligned with the first interchangeable component and a second detector optically aligned with the second interchangeable component.

In another form, the present disclosure is directed to a consumable component that is removably coupleable to a torch that is suitable for welding or cutting operations. The consumable component includes a surface that is optically viewable at an operative end of the torch and a luminescent material that is disposed on the surface. The luminescent material is configured to emit a second electromagnetic energy in response to absorbing at least some of a first electromagnetic energy that is incident on the surface. The second electromagnetic energy has a specific spectral signature that allows the component to be identified.

In at least some embodiments, the consumable component includes at least one of an electrode, a torch tip, a shield cup, and a gas distributor (insofar as this terminology indicates that a consumable component may include any of these components individually or any of these components in combination with any of the other components, and does not require that that the consumable include at least one of each). Additionally or alternatively, the luminescent surface of the interchangeable torch component is a photoluminescent surface or an electroluminescent surface. Still further, in some embodiments, the surface is a rear surface of the consumable component.

In yet another form, the present disclosure is directed to a system include a torch, an electromagnetic energy detector, and a power supply. The torch that can receive an interchangeable torch component. The electromagnetic energy detector detects second electromagnetic energy emitted by a luminescent surface included on the interchangeable torch component, which is configured to emit the second electromagnetic energy in response to absorbing at least some of first electromagnetic energy. The power supply automatically adjusts operational parameters of the torch based on the detected second electromagnetic energy.

In at least some of these embodiments, the electromagnetic energy detector is disposed within the torch. Additionally or alternatively, the power supply may be configured to: (1) determine an identity of the interchangeable torch component based on the detected first electromagnetic energy; and (2) adjust the operational parameters of power delivered to the torch based of the identity.

Still further, in some embodiments, the interchangeable torch component is a first interchangeable torch component, the luminescent surface is a first luminescent surface, and the torch can also receive a second interchangeable torch component with a second luminescent surface. In these instances, the electromagnetic energy detector detects the second electromagnetic energy emitted by the luminescent surface of the first interchangeable torch component and also detects third electromagnetic energy emitted by the second luminescent surface in response to absorbing at least some of the first electromagnetic energy. Additionally, the power supply automatically adjusts the operational parameters based on the detected first electromagnetic energy and the detected third electromagnetic energy. In at least some of these embodiments, in automatically adjusting, the power supply enters a fault mode if the first interchangeable torch component is determined to be incompatible with the second interchangeable torch component based on the detected first electromagnetic energy and the detected third electromagnetic energy.

In still another form, the present disclosure is directed to a method that includes providing first electromagnetic energy incident on a luminescent surface of an interchangeable component installed on a torch suitable for welding or cutting operations. Second electromagnetic energy emitted by the luminescent surface in response to absorbing at least a portion of the first electromagnetic energy is then detected. The interchangeable component is identified based on characteristics of the second electromagnetic energy. In at least some of these embodiments, operational parameters of the torch are automatically adjusting based on the identifying. Moreover, in some embodiments of this method, the interchangeable component is an electrode, a torch tip, a shield cup, or a gas distributor, the luminescent surface is a fluorescent surface, the first electromagnetic energy comprises visible or non-visible light of various wavelengths, and the second electromagnetic energy is fluoresced light.

Although the techniques are illustrated and described herein as embodied in one or more specific examples, the specific details of the examples are not intended to limit the scope of the techniques presented herein, since various modifications and structural changes may be made within the scope and range of the invention. For example, although the use of a fluorescing surface (i.e., absorbing and emitting surface) is described repeatedly herein, the detection of a part/consumable (component) could also be accomplished by measuring the emission of light from a light emitting diode, a hot filament, plasma, or any other source of electromagnetic radiation, included on a component.

In addition, various features from one of the examples discussed herein may be incorporated into any other examples. For example, although the torch in FIGS. 2A and 2C is illustrated without a processor, the processor, as well as any other components illustrated in FIG. 3 can be incorporated into the torch 101 or torch assembly 17 shown in FIGS. 2A and 2C. Similarly, the components/mechanical arrangements shown in FIG. 2A and 2C can be included in the torch of FIG. 3 and the operations depicted in FIGS. 4A can be used with a torch including any combination of features from FIGS. 2A, 2C, and/or 3. Analogously, although the power supply 16 in FIGS. 2A and 2B is illustrated without a processor, the processor, as well as any other components illustrated in FIG. 3 can be incorporated into the power supply 16 shown in FIGS. 2A and 2B. Similarly, the components/mechanical arrangements shown in FIG. 2A and 2B can be included in the power supply of FIG. 3 and the operations depicted in FIGS. 4AB, 5, and 6 can be used with a power supply including any combination of features from FIGS. 2A, 2B, and/or 3. Accordingly, the appended claims should be construed broadly and in a manner consistent with the scope of the disclosure.

We claim:

1. A torch for welding or cutting operations, comprising:
an electromagnetic energy source that generates first electromagnetic energy with various spectral signatures and directs the first electromagnetic energy to a luminescent surface of an interchangeable torch component installed in an operating end of the torch; and
an electromagnetic energy detector that detects second electromagnetic energy emitted by the luminescent surface in response to absorbing at least some of the first electromagnetic energy so that the interchangeable torch component can be identified.

2. The torch of claim 1, wherein the interchangeable torch component is a consumable component.

3. The torch of claim 2, wherein the consumable component includes at least one of an electrode, a torch tip, a shield cup, and a gas distributor.

4. The torch of claim 1, wherein the luminescent surface of the interchangeable torch component is a photoluminescent surface or an electroluminescent surface.

5. The torch of claim 5, wherein the luminescent surface is a fluorescent surface, the first electromagnetic energy with various spectral signatures comprises visible or non-visible light of various wavelengths and the second electromagnetic energy emitted by the luminescent surface is fluoresced light.

6. The torch of claim 1, further comprising:
a torch body that defines the operating end of the torch, wherein the interchangeable torch component is removably securable to the torch body in a manner that operably couples the luminescent surface to the electromagnetic energy source and the electromagnetic energy detector.

7. The torch of claim 1, wherein the interchangeable torch component is a first interchangeable torch component, the luminescent surface is a first luminescent surface, and wherein:
the electromagnetic energy source directs the first electromagnetic energy to the first luminescent surface of the first interchangeable torch component and also directs the electromagnetic energy to a second luminescent surface of a second interchangeable torch component installed in an operating end of the torch; and
the electromagnetic energy detector detects the second electromagnetic energy emitted by the first luminescent surface of the first interchangeable torch component and also detects third electromagnetic energy emitted by the second luminescent surface of the second interchangeable torch component in response to absorbing at least some of the first electromagnetic energy with the various spectral signatures so that the first interchangeable torch component and the second interchangeable torch can be identified.

8. The torch of claim 7, wherein the electromagnetic energy detector includes a first detector optically aligned with the first interchangeable component and a second detector optically aligned with the second interchangeable component.

9. A consumable component that is removably coupleable to a torch that is suitable for welding or cutting operations, the consumable component comprising:
a surface that is optically viewable at an operative end of the torch; and
a luminescent material that is disposed on the surface and configured to emit a second electromagnetic energy in response to absorbing at least some of a first electromagnetic energy that is incident on the surface, wherein the second electromagnetic energy has a specific spectral signature that allows the component to be identified.

10. The consumable component of claim 9, wherein the consumable component includes at least one of an electrode, a torch tip, a shield cup, and a gas distributor.

11. The consumable component of claim 9, wherein the luminescent material of the interchangeable torch component is a photoluminescent surface or an electroluminescent surface.

12. The consumable component of claim 9, wherein the surface is a rear surface of the consumable component.

13. A system, comprising:
a torch that can receive an interchangeable torch component;
an electromagnetic energy detector that detects second electromagnetic energy emitted by a luminescent surface included on the interchangeable torch component, the luminescent surface being configured to emit the second electromagnetic energy in response to absorbing at least some of first electromagnetic energy; and
a power supply that automatically adjusts operational parameters of the torch based on the detected second electromagnetic energy.

14. The system of claim 13, wherein the electromagnetic energy detector is disposed within the torch.

15. The system of claim 13, wherein the power supply:
determines an identity of the interchangeable torch component based on the detected second electromagnetic energy; and
adjusts the operational parameters of power delivered to the torch based of the identity.

16. The system of claim 13, wherein the interchangeable torch component is a first interchangeable torch component, the luminescent surface is a first luminescent surface, and wherein:
the torch can also receive a second interchangeable torch component with a second luminescent surface;
the electromagnetic energy detector detects the second electromagnetic energy emitted by the luminescent surface of the first interchangeable torch component and also detects third electromagnetic energy emitted by the second luminescent surface in response to absorbing at least some of the first electromagnetic energy; and
the power supply automatically adjusts the operational parameters based on the detected second electromagnetic energy and the detected third electromagnetic energy.

17. The system of claim 16, wherein, in automatically adjusting, the power supply enters a fault mode if the first interchangeable torch component is determined to be incompatible with the second interchangeable torch component based on the detected second electromagnetic energy and the detected third electromagnetic energy.

18. A method, comprising:
providing first electromagnetic energy incident on a luminescent surface of a interchangeable component installed on a torch suitable for welding or cutting operations;
detecting second electromagnetic energy emitted by the luminescent surface in response to absorbing at least a portion of the first electromagnetic energy; and
identifying the interchangeable component based on characteristics of the second electromagnetic energy.

19. The method of claim 18, further comprising:
automatically adjusting operational parameters of the torch based on the identifying.

20. The method of claim 18, wherein:
the interchangeable component includes at least one of an electrode, a torch tip, a shield cup, or a gas distributor;
the luminescent surface is a fluorescent surface;
the first electromagnetic energy comprises visible or non-visible light of various wavelengths; and
the second electromagnetic energy is fluoresced light.
